(19) United States
(12) Patent Application Publication
(10) Pub. No.: US 2021/0364995 A1
(43) Pub. Date: Nov. 25, 2021

(54) Integrated Monitoring, Time-Driven- and Feedback-Control, User Interface, and Plant ID Tracking Systems and Methods for Closed Horticulture Cultivation Systems

(71) Applicant: Mankaew Muanchart, Surin (TH)

(72) Inventors: Bhadhada KONGSOM-UT, Surin (TH); Mankaew MUANCHART, Surin (TH)

(73) Assignee: Mankaew Muanchart

(21) Appl. No.: 17/327,537

(22) Filed: May 21, 2021

Related U.S. Application Data
(60) Provisional application No. 63/029,193, filed on May 22, 2020.

(51) Int. Cl. G05B 19/042; A01G 7/00

(52) U.S. Cl. CPC G05B 19/042; G05B 2219/25252; G05B 2219/23258; A01G 7/00

(57) ABSTRACT

The invention provides for computational and networking environment arrangements to co-coordinate the activities, roles, operation, maintenance, and optimal use of multiple plant-cultivation enhancement and monitoring technology subsystems including mechanical, illumination, chemical, biochemical, hydraulic, thermal, pneumatic, electronic, electrical, computational, informational, sensor, measurement, control, analysis, modeling, logging, database, and networking, as well as other technologies. Additionally, sensors and/or plant environment equipment items can be an Internet of Things (IoT) entity. Individual plants can be assigned an identification “ID” that can be used to track individual plants as to environment, history, introduction, removal, and health. Individual plants can be provided with RFID tags or tags that operate as an Internet of Things (IoT) entity. The invention provides for strategies for a wide range of user interfaces types and provides for flexible readily-customizable implementations. Example GUI types include capabilities for user settings, operating mode, configuration, monitoring, logging, analysis, testing, and diagnostics.

### CROSS-REFERENCE TO RELATED APPLICATIONS

This application claims priority to U.S. Provisional Patent Application No. 63/029,193, filed May 22, 2020, the contents of which are incorporated herein by reference.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### BACKGROUND OF THE INVENTION

### Field of the Invention

The invention pertains to closed horticulture cultivation systems, and more specifically to both human and automatic monitoring and control of such systems, the conditions and materials within the system, and plants and other organisms living within the system.

### Overview of the Invention

Closed horticulture cultivation systems will be an important new food production and commercial plant production technology. In one important aspect, closed horticulture cultivation systems permit the production of food in arbitrary geographical areas and in particular are well-suited for urban-area food production. Further, both in this aspect and others, closed horticulture cultivation systems provide a natural setting for leveraging mechanical, illumination, chemical, biochemical, hydraulic, thermal, pneumatic, electronic, electrical, computational, informational, sensor, measurement, control, analysis, modeling, logging, database, networking, and other technologies to significantly increase production quantities, qualities, and cultivation species opportunities.

Although various separate and isolated technological subsystems directed to plant cultivation can be used individually or in ad hoc combinations, there is both a need and an opportunity to create larger-scale unified, extensible, configurable, and/or easily-operated and easily-customizable closed horticulture cultivation meta-systems that can at minimum unitarily coordinate, monitor, and log data of ensembles of plant cultivation enhancement and monitoring technologies. Further, such unitary integration provides opportunities to co-coordinate the activities, roles, operation, maintenance, and optimal use of multiple plant cultivation enhancement and monitoring technology subsystems.

Accordingly the present invention is directed to providing a computational and networking environment to co-coordinate the activities, roles, operation, maintenance, and optimal use of multiple plant cultivation enhancement and monitoring technology subsystems including mechanical, illumination, chemical, biochemical, hydraulic, thermal, pneumatic, electronic, electrical, computational, informational, sensor, measurement, control, analysis, modeling, logging, database, and networking, as well as other technologies.

### SUMMARY OF INNOVATION

For purposes of summarizing, certain aspects, advantages, and novel features are described herein. Not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

The invention provides for computational and networking environment arrangements to co-coordinate the activities, roles, operation, maintenance, and optimal use of multiple plant-cultivation enhancement and monitoring technology subsystems including mechanical, illumination, chemical, biochemical, hydraulic, thermal, pneumatic, electronic, electrical, computational, informational, sensor, measurement, control, analysis, modeling, logging, database, and networking, as well as other technologies.

In another aspect of the invention, an industrial computer module, microprocessor, or embedded controller is used to interface with plant environment equipment and plant environment sensors, and conventional desktop, laptop, or table computers, smartphones, and other similar devices are used to provide user interfaces.

In another aspect of the invention, the industrial computer module, microprocessor, or embedded controller to connect with conventional desktop, laptop, or table computers, smartphones, and other similar devices (used to provide user interfaces) via a local network or the internet, although direction connections (such as USB, RS-232, I²C, SPI, etc.) can be used.

In another aspect of the invention, at least some plant environment equipment is controlled by controllable electrical power. Such controllable powering arrangements are typically controlled by a provided data input or network interface. These data inputs or network interfaces can then be used to connect the controllable powering arrangements for plant environment equipment with computing element(s) provided for by the invention.

In another aspect of the invention, individual plants are assigned an identification code or number (“ID”).

In another aspect of the invention, individual plants are subsequently tracked for plant environment, plant history, plant introduction, plant removal, and plant health.

In another aspect of the invention, a plant environment sensor can be an Internet of Things (IoT) entity.

In another aspect of the invention, at least some plant environment equipment items can be an Internet of Things (IoT) entity.

In another aspect of the invention, clock time-of-day and event-duration information is available to computational elements and algorithms.

In another aspect of the invention, one or more conventional desktop, laptop, or table computers, smartphones, and other similar devices (used to provide user interfaces) can interconnect with the example framework via a local network (such as WiFi, Ethernet™, etc.) Bluetooth™, direction connections (such as USB, RS232, SPI, I²C, etc.), and/or the internet.

In another aspect of the invention, such local network and internet connections can provide access to local or remote servers, databases, cloud storage, cloud computing, authentication, and other online resources.

In another aspect of the invention, illumination and machinery can be controlled by at least time-driven control responsive to time values specified by a user interface and the current time as specified by a system clock.

In another aspect of the invention, illumination and machinery can be controlled by at least event-driven control responsive to events specified by a user interface and events known to the controller software as reported, observed, or commanded.

In another aspect of the invention, illumination and machinery can be controlled by at least closed loop automatic control responsive to setting values specified by a user interface, database, or list and additionally responsive to one or more sensors.

In another aspect of the invention, illumination and machinery can be controlled by at least direct control from a user interface.

In another aspect of the invention, various computation operations can be performed by one or more algorithm(s) subject to provided parameters, types, modes, and software-defined interconnection topology configurations.

In another aspect of the invention, the computation operations can include at least conditional logic, numerical calculation, and dynamic controller functions (such as PID, Bang-Bang, etc.).

In another aspect of the invention, user interfaces can be used to enter user setting operating parameter values, operating mode(s), and configuration data.

In another aspect of the invention, configuration data can include which sensors and equipment are connected to what communications port, network, and/or network address.

In another aspect of the invention, configuration data can include descriptions of the computational flow for specific sensor input data and equipment control values.

In another aspect of the invention, configuration data can include instances and types of conditional logic, numerical calculation, dynamic controller functions, and other computational operations.

In another aspect of the invention, configuration data can include interconnection topology among inputs, outputs, conditional logic, numerical calculation, dynamic controller functions, and other computational operations,

In another aspect of the invention, configuration data can include what specific information is monitored;

In another aspect of the invention, configuration data can include what information is logged;

In another aspect of the invention, configuration data can include what information is made available for analysis

In another aspect of the invention, configuration data can include what information is made available for diagnostics.

In another aspect of the invention, some, most or all of information received, transmitted, stored, and computed above can be set up for monitoring.

In another aspect of the invention, some, most or all of information received, transmitted, stored, and computed above can be set up for logging.

In another aspect of the invention, some, most or all of information received, transmitted, stored, and computed above can be set up for analysis.

In another aspect of the invention, some, most or all of information received, transmitted, stored, and computed above can be set up for diagnostics.

In another aspect of the invention, information values and flows can be stored for a window in time or indefinitely in a Measurement and Activities Log(s) or similar storage function.

In another aspect of the invention, monitored data can be presented in various tabular or graphical ways.

In another aspect of the invention, logged data can be presented in various tabular or graphical ways.

In another aspect of the invention, additional analysis functions and tools can be linked or networked with at least one analysis GUI.

In another aspect of the invention, algorithms could be executed by at least one or more of an industrial computer module, microprocessor, or embedded controller entity.

In another aspect of the invention, algorithms could be executed by at least one or more of a conventional desktop, laptop, or table computer, smartphone, and other similar device.

In another aspect of the invention, algorithms could be executed by at least one or more of a local or remote servers, databases, cloud storage, cloud computing, authentication, and other online resources.

In another aspect of the invention, interfacing and data/graphics exchange with internal statistical analysis tools is provided.

In another aspect of the invention, interfacing and data/graphics exchange with external general purpose statistical analysis tools such as S, R, Mathematica™, MatLab™, etc., is provided.

In another aspect of the invention, interfacing and data/graphics exchange with external and/or internal plant science analysis tools is provided.

In another aspect of the invention, interfacing and data/graphics exchange with external and/or internal agricultural yield or production analysis tools is provided.

In another aspect of the invention, interfacing and data/graphics exchange with external and/or internal plant pathogen analysis tools is provided.

In another aspect of the invention, computation operations can be performed by one or more algorithm(s) subject to provided parameters, types, modes, and software-defined interconnection topology configurations.

In another aspect of the invention, the computation operations can include, for example conditional logic, numerical calculation, dynamic controller functions, etc., but are hardly limited by these.

In one aspect of the invention, an Application Programmer Interface (“API”) is provided with the controlling and monitoring software so as to allow other manufactures to implement GUIs for monitoring, control, analysis, and other GUI-oriented functions.

In another aspect of the invention, the invention includes GUI software arranged so that a third-party software product manufacturer, controller product manufacturer, or closed horticulture cultivation systems product manufacturer to easily adjust software for different product models, or feature additions.

In another aspect of the invention, the invention includes GUI software arranged so that ranges of user interface complexities to be made available.

In another aspect of the invention, the invention includes GUI software arranged so that customers/users to customize to GUIs for use by unskilled plant attendants, customize to a specific crop, customize to monitor for a plant disease/recovery, etc.

In another aspect of the invention, the invention includes GUI software arranged to provide wide opportunities for the manufacturer of OEM/“white-label” software to other manufacturers and allow those manufacturers to change the look, organization, and presented features of the GUI.

In another aspect of the invention, flexible/customizable GUI feature selection is provided.

In another aspect of the invention, flexible/customizable GUI look-and-feel is provided.

In another aspect of the invention, various subsets of the available display and control objects are selected to create a particular type of GUI.

In another aspect of the invention, subsets of available objects chosen for a particular GUI type can be shared by more than one GUI type.

In another aspect of the invention, subsets of available objects chosen for a particular GUI type can be uniquely dedicated to a particular GUI type.

In another aspect of the invention, subsets of available objects chosen for a particular GUI type can be uniquely dedicated to a particular GUI type.

In another aspect of the invention, GUIs can be implemented with traditional application software methods.

In another aspect of the invention, traditional application software GUIs can be implemented using a “skins” programming pattern.

In another aspect of the invention, GUIs can be implemented as webpages.

In another aspect of the invention, webpage-based GUIs can be implemented using Cascading Style Sheets (CSS).

In another aspect of the invention, a GUI is provided for user settings.

In another aspect of the invention, a GUI is provided for operating mode.

In another aspect of the invention, a GUI is provided for configuration.

In another aspect of the invention, a GUI is provided for monitoring.

In another aspect of the invention, a GUI is provided for logging.

In another aspect of the invention, a GUI is provided for analysis.

In another aspect of the invention, a GUI is provided for testing.

In another aspect of the invention, a GUI is provided for diagnostics.

In another aspect of the invention, a GUI provides for entering, reviewing, and changing a user setting.

In another aspect of the invention, a GUI provides for entering, reviewing, and changing an operating mode.

In another aspect of the invention, a GUI provides for entering, reviewing, and changing a configuration.

In another aspect of the invention, a GUI provides for monitoring.

In another aspect of the invention, a GUI provides for logging.

In another aspect of the invention, a GUI provides for analysis.

In another aspect of the invention, a GUI provides for testing.

In another aspect of the invention, a GUI provides for diagnostics.

In one aspect of the invention, a system is provided for a computational and networking system to co-coordinate the activities, roles, operation, maintenance, and optimal use of multiple plant-cultivation enhancement and monitoring technology subsystems, the system comprising:
A computational element for executing at least one algorithm comprised by software, the at least one algorithm comprising configurable sensor input functions, configurable numerical computation operations, configurable logic operations, configurable dynamic controller operations, and configurable control output functions, the computational element further having network capabilities and provisions for control by user interfaces, the computational element further having interfacing capabilities to interface with sensors, controllable illumination, and controllable machinery; and
At least one graphical user interface algorithm comprised by software for executing on a computational device, the computational device having network capabilities and networked to the computational element, the graphical user interface algorithm and computational device exchanging information with the computational element and at least one algorithm,
Wherein the configurable sensor input functions, configurable numerical computation operations, configurable logic operations, configurable dynamic controller operations, and configurable control output functions are individually configured by information received by the graphical user interface algorithm; and
Wherein interconnections of information exchange among the configurable sensor input functions, configurable numerical computation operations, configurable logic operations, configurable dynamic controller operations, and configurable control output functions are individually configured by information received by the graphical user interface algorithm.

### BRIEF DESCRIPTION OF THE DRAWINGS

The above and other aspects, features and advantages of the present invention will become more apparent upon consideration of the following description of preferred embodiments taken in conjunction with the accompanying drawing figures, wherein:

FIG. 1A depicts a representative example framework for an example setting, scope, and function the invention. It is noted that a wide range of alternatives and varying levels of component count, features, and complexity are also provided for by the invention.

FIG. 1B depicts a range of representative example arrangements for user interfacing, networking, servers, databases, clouds, and related functions that the invention provides for interfacing with a framework of the invention such as the example framework depicted in FIG. 1. A wide range of alternative arrangements are also provided for by the invention.

FIG. 2 depicts a representative example software structure for the control aspects and monitoring aspects of the invention. It is again noted that a wide range of alternatives and varying levels of component count, features, and complexity are also provided for by the invention.

FIG. 3 depicts a representative example interconnection of the example software structure of FIG. 3 with user interfaces (here represented as “Graphical User Interfaces”/“GUIs”) as well as networking and logging systems.

FIG. 4 depicts a representative example arrangement of analysis software tools, noting that a wide range of alternatives and varying levels of component count, features, and complexity are also provided for by the invention.

FIG. 5 depicts a representative example arrangement of the interconnection of an example ensemble of sensors (including any support and interfacing electronics) with computational processing executing software algorithms, communications, electrical connections, and/or signal aggregation. A wide range of alternatives and levels of complexity are provided for by the invention.

FIG. 6 depicts a representative example arrangement of the interconnection of example collection of mechanical, illumination, hydraulic, thermal, pneumatic, electronic, and electrical subsystems with computational processing executing software algorithms, communications and/or electrical connections/distribution. A wide range of alternatives and levels of complexity are provided for by the invention.

FIG. 7A depicts a representative example implementation of an example flexible GUI feature selection capabilities in accordance with the invention with the understanding that there are a wide range of alternatives and levels of complexity are additionally provided for by the invention.

FIG. 7B depicts a representative example implementation of example flexible GUI look-and-feel capabilities provided for by the invention with the understanding that there are a wide range of alternatives and levels of complexity are additionally provided for by the invention.

### DETAILED DESCRIPTION

In the following description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention.

In the following description, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

### 1. Example Framework Architecture for a Wide Range of Multi-Technology Closed Horticulture Cultivation Systems

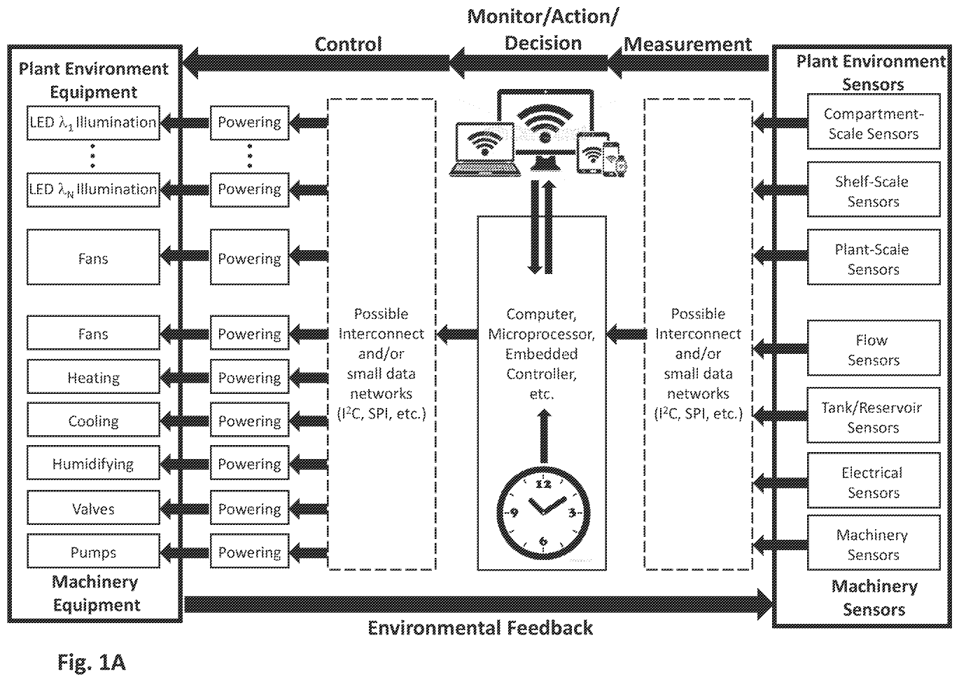

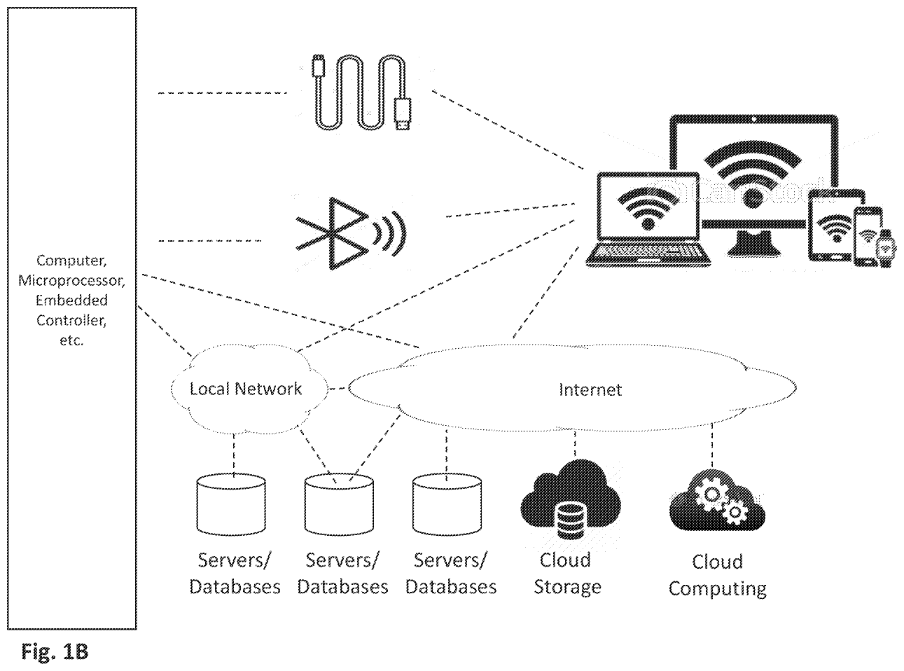

FIG. 1A depicts a representative example framework for an example setting, scope, and function of the invention. It is noted that a wide range of alternatives and varying levels of component count, features, and complexity are also provided for by the invention.

In the abstract representative example framework of FIG. 1A, portions of an overall closed horticulture plant cultivating environment and it supporting systems and structures are functionally portioned into a collection of plant environment sensors (right side of the drawing) and a collection of plant environment equipment (left side of the drawing). It is noted that other arrangements are possible and provided for by the invention—for example an item of plant environment equipment could internally include sensors, or an item of plant environment equipment a plant environment sensor could be organized as an Internet of Things (IoT) entity, in which case the computing element(s) depicted in the center column of FIG. 1A could interface with such Internet of Things (IoT) entities over a local network or the internet. Although slightly differing architecturally, such Internet of Things (IoT) entities will be represented as if they were compliant with the collection of plant environment sensors (right side of the drawing) and a collection of plant environment equipment (left side of the drawing). Interconnections of the computing element(s) depicted in the center column of FIG. 1A with local networks and the internet will be discussed shortly.

In the invention, the various items within the collection of plant environment equipment would be typically controlled by controllable electrical power as suggested by the controlled powering arrangements depicted to the right of the collection of plant environment equipment in FIG. 1A. Such controllable powering arrangements are typically controlled by a provided data input or network interface. These data inputs or network interfaces can then be used to connect the controllable powering arrangements for plant environment equipment with computing element(s) depicted in the center column of FIG. 1A.

It is noted that other arrangements are possible and provided for by the invention—for example an item of plant environment equipment could be directly controlled by a data input or network interface, and can for example be an Internet of Things (IoT) entity.

Similarly the various items within the collection of plant environment sensors typically are supported with sensor interfacing electronics although this is not explicitly shown in FIG. 1A. Such sensor interfacing electronics typically provide and include a data output or network interface. These data outputs or network interfaces can then be used to connect the plant environment sensors with computing element(s) depicted in the center column of FIG. 1A. It is noted that other arrangements are possible and provided for by the invention—for example a plant environment sensor could be directly controlled by a data input or network interface, and can for example be an Internet of Things (IoT) entity.

The computing element(s) depicted in the center column of FIG. 1A can include an industrial computer module, microprocessor, embedded controller, etc. as well as conventional desktop, laptop, or table computers, smartphones, and other similar devices. In a typical implementation of the invention an industrial computer module, microprocessor, or embedded controller is used to interface with the plant environment equipment and plant environment sensors as described above, and conventional desktop, laptop, or table computers, smartphones, and other similar devices are used to provide user interfaces. Further, in a typical implementation of the invention it can be advantageous for the industrial computer module, microprocessor, or embedded controller to connect with conventional desktop, laptop, or table computers, smartphones, and other similar devices (used to provide user interfaces) via a local network or the internet, although direction connections (such as USB RS-232, I²C, SPI, etc.) can be used. It is noted that wide range of alternative arrangements are also provided for by the invention. Interconnections of the computing element(s) depicted in the center column of FIG. 1A with local networks and the internet will be discussed next.

As shown in the lower center of FIG. 1A, clock time-of-day and event-duration information is available to the computational elements.

FIG. 1B depicts a range of representative example arrangements for supporting user interfacing, networking, servers, databases, clouds, and related functions for interfacing with the example framework depicted in FIG. 1.

As mentioned above, one or more conventional desktop, laptop, or table computers, smartphones, and other similar devices (used to provide user interfaces) can interconnect with the example framework depicted in FIG. 1 via a local network (such as WiFi, Ethernet™, etc.) Bluetooth™, direction connections (such as USB, RS232, SPI, I²C, etc.), and/or the internet. Such local network and internet connections can provide access to local or remote servers, databases, cloud storage, cloud computing, authentication, and other online resources. It is noted that wide range of alternative arrangements are also provided for by the invention.

In another aspect of the invention, individual plants can be assigned assigned an identification code or number (“ID”). This ID number can be used to track individual plants for plant environment, plant history, plant introduction, plant removal, and plant health. In one implementation, individual plants can be provided with RFID tags. In another implementation, individual plants can be provided with a tag that operates as an Internet of Things (IoT) entity.

### 2. Example Architecture for Control and Monitoring Computation and Interfacing Software

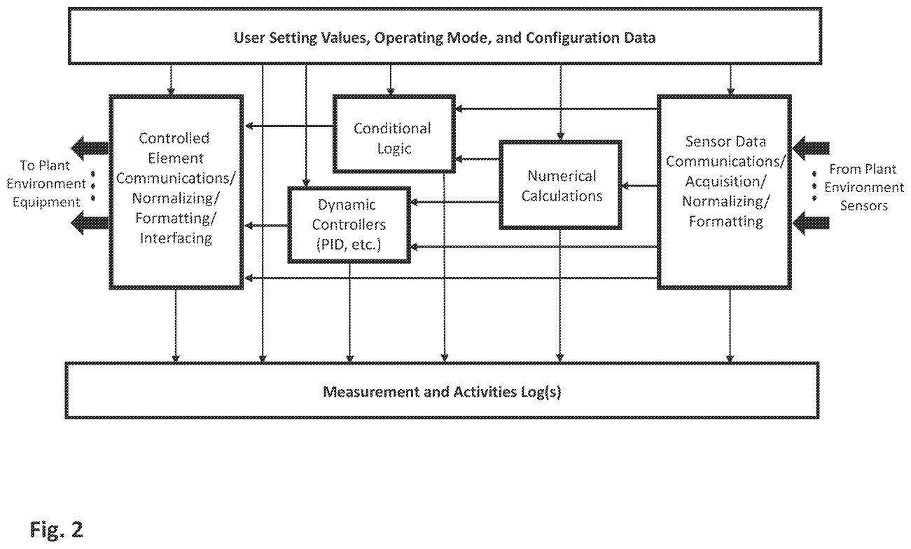

FIG. 2 depicts a representative example software structure for the control aspects and monitoring aspects of the invention. Algorithms for these functions could typically be executed by at least the computing element(s) depicted in the center column of FIG. 1A although cloud computing can be used. Further, algorithms for these functions and capabilities could typically be executed principally by a industrial computer module, microprocessor, or embedded controller entity depicted within the center column of FIG. 1A. It is again noted that a wide range of alternatives and varying levels of component count, features, and complexity are also provided for by the invention.

Although other arrangements are clearly possible, sensor input communication and equipment control communication would typically be included in the invention software and accordingly these are depicted respectively on the right and left sides of FIG. 2. Although not explicitly shown in FIG. 2, clock time-of-day and event-duration information is available throughout as called out in FIG. 1A. Between these input and output interfaces, various computation operations can be performed by one or more algorithm(s) subject to provided parameters, types, modes, and software-defined interconnection topology configurations. The computation operations can include, for example conditional logic, numerical calculation, dynamic controller functions, etc., but are hardly limited by these.

User interfaces can be used to enter user setting operating parameter values, operating mode(s), and configuration data. This information is stored as represented by the box at the top of FIG. 2. Configuration data can include what specific sensors and equipment are connected to what communications port, network, and/or network address. Configuration data can include but are not limited to:
descriptions of the computational flow for specific sensor input data, equipment control values, etc.;
instances and types of conditional logic, numerical calculation, dynamic controller functions, and other computational operations;
interconnection topology among inputs, outputs, conditional logic, numerical calculation, dynamic controller functions, and other computational operations,
what specific information is monitored;
what specific information is logged;
what specific information is made available for analysis
what specific information is made available for diagnostics.

All of information received, transmitted, stored, and computed above can in principle be set up for monitoring, logging, analysis, and diagnostics. Both values and information flows can be stored for a window in time or indefinitely in the Measurement and Activities Log(s) depicted at the bottom of FIG. 2. User interfaces can be arranged to present monitored and logged data in various tabular or graphical ways.

3. Interconnection Example Architectures with Networking and User Interfaces

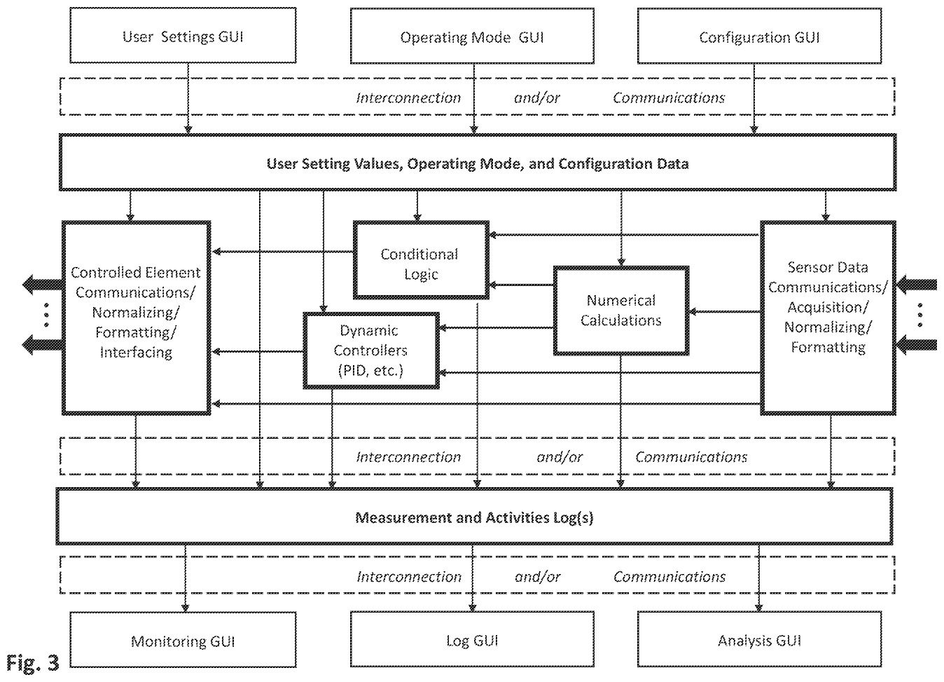

FIG. 3 depicts a representative example interconnection of the example software structure of FIG. 3 with user interfaces (here represented as “Graphical User Interfaces”/“GUIs”) as well as networking and logging systems.

Although not shown, diagnostics tools and other applications can also interface with at least the Measurement and Activities Log(s) depicted at the bottom of FIG. 2. In various implementations other information handled or created by the various entities depicted in FIG. 2 or extensions of those as provided for or anticipated by the present invention, as well as augmentations and variations of the present invention.

### 4. Example Analysis Tool Arrangements

In addition to presenting monitored and logged data in various tabular or graphical ways, the invention also provides for a wide range of additional analysis functions and tools. These can

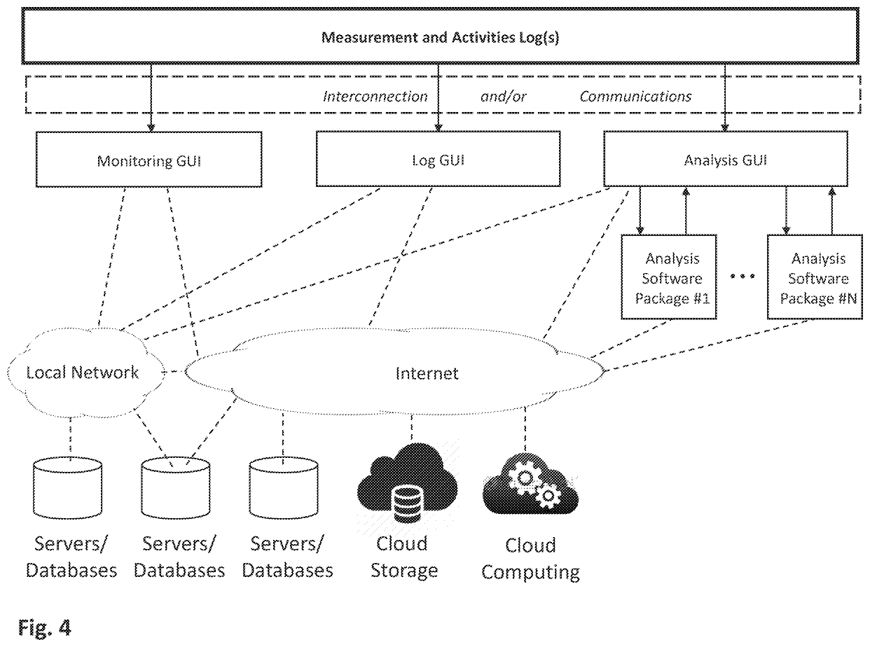

FIG. 4 depicts a representative example arrangement of analysis software tools. It is note that a wide range of alternatives and varying levels of component count, features, and complexity are also provided for by the invention.

Example analysis tools and arrangements for interfacing with them can include, among others:
Interfacing and data/graphics exchange with internal statistical analysis tools,
Interfacing and data/graphics exchange with external general purpose statistical analysis tools such as S, R, Mathematica™, MatLab™, etc.,
Interfacing and data/graphics exchange with external and/or internal plant science analysis tools,
Interfacing and data/graphics exchange with external and/or internal agricultural yield or production analysis tools,
Interfacing and data/graphics exchange with external and/or internal plant pathogen analysis tools.

It is noted that a wide range of alternatives and levels of complexity are additionally provided for by the invention.

### 5. Sensors in Plant Environments

As suggested by FIG. 1, a wide variety of sensors can be useful in both monitoring and closed loop automatic control of illumination and machinery for the plant compartment of a closed horticulture cultivation system. It is noted that various sensors can be (by functionally) located in the air flow, in soil, in fluid conduits, in tanks, in the vicinity of specific plants, in specific geometric regions of the plant environment, on an individual plant, etc.

A representative example practical collection of sensor types of an actual practical operative multi-technology closed horticulture cultivation system can include:
Gas Concentration (CO₂, O₂, N₂, N₂O, NH₃, He, CH₄, C₂H₂, etc.)
Recipe Light Intensities (PPF₁, PPF₂, PPF₃, . . . )
Recipe Light Spectrum (λ₁, λ₂, λ₃, . . . )
Atmosphere Light Intensities (AL)
Room Temperature (RT)
Atmosphere Temperature (AT)
Leaves Temperature (LT1, LT2, LT3, . . . )
Injected Gas Colloid Temperature (IGT1, IGT2, IGT3, . . . )
Returned Gas Colloid Temperature (RGT1, RGT2, RGT3, . . . )
Liquid Temperature (in Humidifier) (HMT1, HMT2, HMT3, . . . )
Root Chamber Temperature (RCT1, RCT2, RCT3, . . . )
Inlet Air Flow Temperature (ITC1, ITC2, ITC3, . . . )
Outlet Air Flow Temperature (OTC1, OTC2, OTC3, . . . )
Nutrient Tank Temperature (NTT1, NTT2, NTT3, . . . )
Return Tank Temperature (RTT1, STT2, RTT3, . . . )
Raw Water Temperature (RWT)
Inlet Water Temperature (IWT)
Liquid Velocity (LF1, LF2, LF3, . . . )
Inlet Air Velocity (IAV1, IAV2, IAV3, . . . )
Suction Air Velocity (SAV1, SAV2, SAV3, . . . )
Discharge Air Velocity (DAV1, DAV2, DAV3, . . . )
Inlet Gas Colloid Velocity (IGV1, IGV2, IGV3, . . . )
Outlet Gas Colloid Velocity (OGV1, OGV2, OGV3, . . . )
Room Humidity (RH)
Atmosphere Temperature (AH)
Plant Weight (PW1, PW2, PW3, . . . )
Liquid Nutrient pH
Liquid Nutrient Ion Composite
Tank Level Sensor (TLV1, TLV2, TLV3, . . . )
Return Tank Level Sensor (RLV1, RLV2, RLV3, . . . )
   However a wide range of alternatives, variations, and levels of complexity are provided for by the invention.

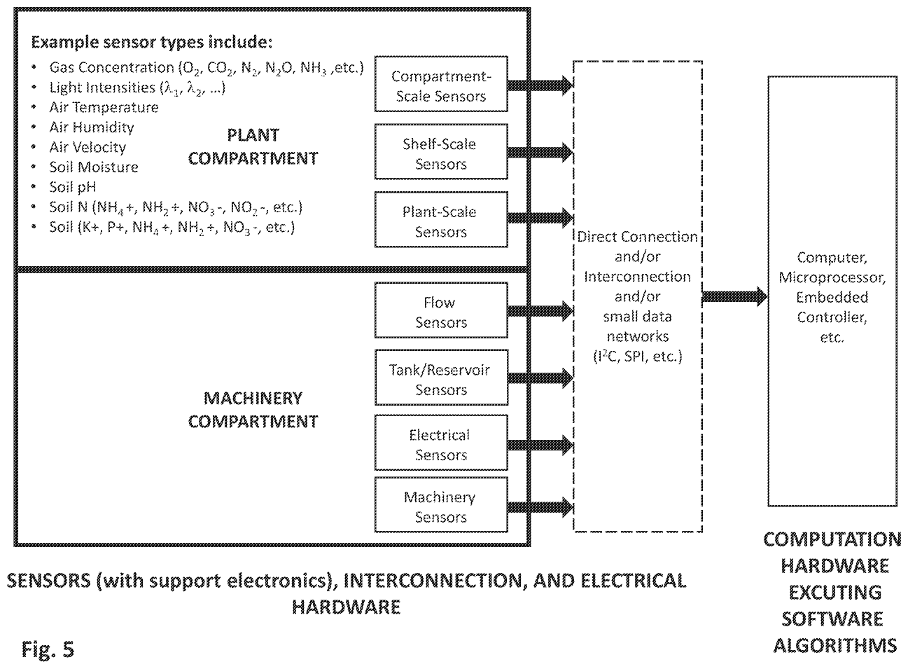

FIG. 5 depicts a representative example arrangement of the interconnection of an example ensemble of sensors (including any support and interfacing electronics) with computational processing and monitoring system and software algorithms executing on it, communications, electrical connections, and/or signal aggregation. Although FIG. 1 and FIG. 5 support wide possible scope, not all sensors need be included in an implementation, and a wide range of alternatives and levels of complexity are additionally provided for by the invention.

### 6. Illumination and Machinery in Plant Environments

As suggested by FIG. 1, a wide variety of illumination and machinery can be included within or to support the plant compartment of a closed horticulture cultivation system. As described earlier, such illumination and machinery can be controlled by one or more means, individually or in combination, for example including:
Time-driven control responsive to time values specified by a user interface and the current time as specified by a system clock.
Event-driven control responsive to events specified by a user interface and events known to the controller software as reported, observed, or commanded.
Closed loop automatic control responsive to setting values specified by a user interface, database, or list and additionally responsive to one or more sensors;
Direct control from a user interface.

A representative example practical collection of sensor types of an actual practical operative multi-technology closed horticulture cultivation system can include:
Full-spectrum illumination, for example via incandescent electrical light sources;
Narrow-band illumination, for example via Light-Emitting Diodes (LEDs);
Fans, blowers, etc.;
Heating elements, cooling elements, Peltier thermoelectric elements, etc.;
Humidifiers (drip, rotating drum, etc.);
Misting elements and associated pumps;
Controllable air baffles, controllable air vents;
Fluidic flow valves, gas flow valves, etc.;
Fluidic metering valves (for example for nutrient and pH titrations), gas metering valves, etc.;
Fluidic flow pumps, gas flow pumps, etc.;
Fluidic metering pumps (for example for nutrient and pH titrations), gas metering pumps, etc.
   However, a wide range of alternatives, variations, and levels of complexity are provided for by the invention.

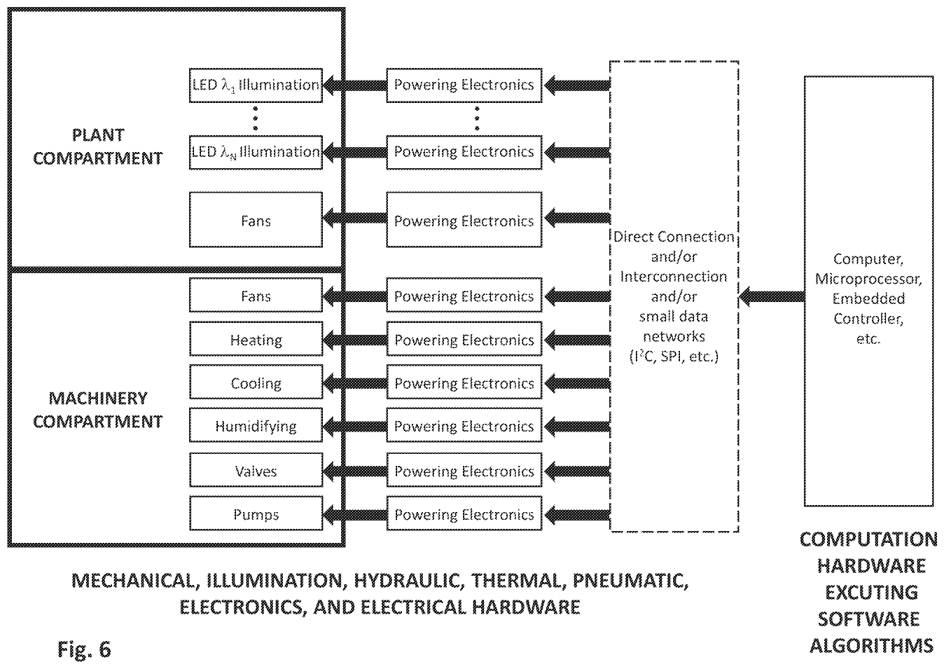

FIG. 6 depicts a representative example arrangement of the interconnection of example collection of mechanical, illumination, hydraulic, thermal, pneumatic, electronic, and electrical subsystems with computational processing executing software algorithms, communications and/or electrical connections/distribution. A wide range of alternatives and levels of complexity are provided for by the invention.

Although FIG. 1 and FIG. 6 support wide possible scope, not all of the equipment items or elements need be included in an implementation, and a wide range of alternatives and levels of complexity are additionally provided for by the invention.

### 7. Example Flexible User Interface Arrangements

In one aspect of the invention, an Application Programmer Interface (“API”) is provided with the controlling and monitoring software so as to allow other manufactures to implement GUIs for monitoring, control, analysis, and other GUI-oriented functions. In another or alternative aspect of the invention, GUIs are explicitly included and provided as part of an overall unitary implementation of the invention. It is noted that there are a wide range of alternatives and levels of complexity are additionally provided for by the invention.

Although it is possible to provide a fixed form or user interface, there are many opportunities and needs for adaptable and customizable user interface aspects. These can include for example:
Creates wide opportunities for the manufacture of OEM/“white-label” software to other manufacturers, allow those manufacturers to change the look, organization, and presented features of the GUI;
Allows a software product manufacturer, controller product manufacturer, or closed horticulture cultivation systems product manufacturer to easily adjust software for different product models, or feature additions;
Allows for ranges of user interface complexities to be provided or made available;
Allows customers/users to customize to GUIs for use by unskilled plant attendants, customize to a specific plant crop, customize to monitor for a plant disease/recovery, etc.
   Although many other methods, techniques, and approaches are possible and can be used, two examples are considered here:
Flexible/customizable GUI feature selection, and
Flexible/customizable GUI look-and-feel.

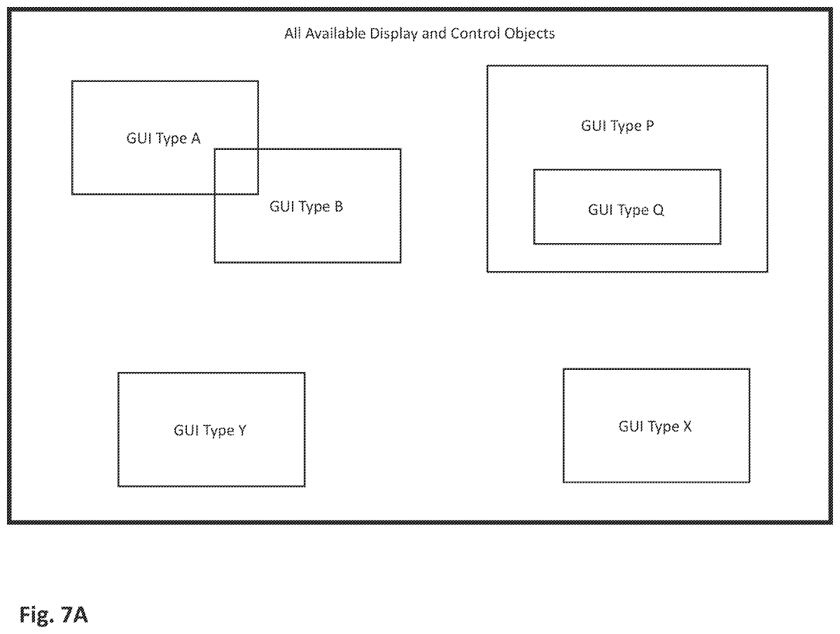

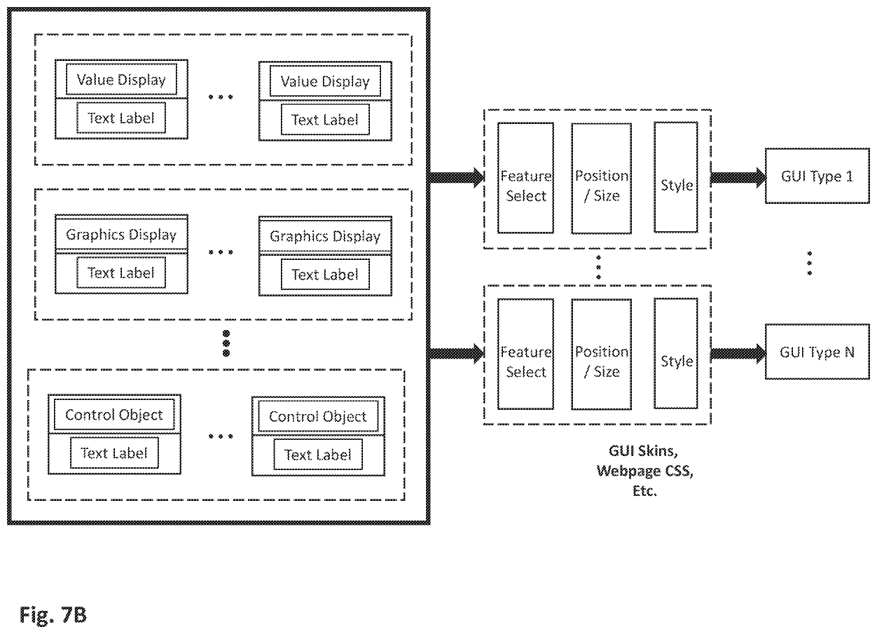

FIG. 7A depicts a representative example implementation of an example flexible GUI feature selection capabilities in accordance with the invention. Various GUI options can be organized in various ways as may suit an application, task, user-experience organizational structure, operator skill level, etc. In the example of FIG. 7, various subsets of the available display and control objects are selected to create a particular type of GUI. Subsets of these available objects that are chosen for a particular GUI type. Various allocation and sharing strategies can be used, for example:
Subsets of available objects chosen for a particular GUI type can be shared by more than one GUI type, for example as suggested in FIG. 7a by the overlapping collections of objects used by example GUI types A and B.
Subsets of available objects chosen for a particular GUI type can be uniquely dedicated to a particular GUI type, for example as suggested in FIG. 7a by the non-overlapping collections of objects used by example GUI types X and Y.
Subsets of available objects chosen for a particular GUI type can be hierarchically shared among at least two GUI types, for example as suggested in FIG. 7a by the hierarchical overlapping collection of objects used by example GUI type P and example GUI type Q whose selected collection of objects is a lesser subset of the collection of objects employed by GUI type P.

As stated above, various GUI options can be organized in various ways as may suit an application, task, user-experience organizational structure, operator skill level, etc. For example, GUIs can be arranged with features selected and grouped by function type, for example as in the six types of GUIs identified in FIG. 4 (“user settings,” “operating mode,” “configuration,” “monitoring,” “log,” “analysis”). Additionally or alternatively, GUIs can be arranged with features selected and grouped by task type (daily operation, operating point, maintenance, alarms, testing, fault-isolation, plant pathology treatment, etc.). Additionally or alternatively, GUIs can be arranged with features selected and grouped by user skill level, with simple forms of user interfaces (omitting most features) provided for daily use, and one or more specialized detailed user interfaces can be provided for specialized needs, servicing alarms, testing, fault localization, changing in operating parameters etc. Further, such a spectrum of user interfaces can include security and permission features. For example, a low-level worker could be precluded from changing key operating parameters by not making those features available in a low-level user interface, while higher-level user interfaces that provide access to changing key operating parameters could be arranged to require specific passwords. It is noted that there are a wide range of alternatives and levels of complexity are additionally provided for by the invention.

FIG. 7B depicts a representative example implementation of example flexible GUI look-and-feel capabilities provided for by the invention. In one approach, for example for GUIs implemented with traditional application software a “skins” programming pattern formality can be used. In another approach, for example for GUIs implemented as webpages executing on a web browser, Cascading Style Sheets (CSS) can be used. It is noted that there are a wide range of alternatives and levels of complexity are additionally provided for by the invention.

### CLOSING

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

Although exemplary embodiments have been provided in detail, various changes, substitutions and alternations could be made thereto without departing from spirit and scope of the disclosed subject matter as defined by the appended claims. Variations described for the embodiments may be realized in any combination desirable for each particular application. Thus particular limitations and embodiment enhancements described herein, which may have particular advantages to a particular application, need not be used for all applications. Also, not all limitations need be implemented in methods, systems, and apparatuses including one or more concepts described with relation to the provided embodiments. Therefore, the invention properly is to be construed with reference to the claims.

We claim:

1. A computational and networking system to co-coordinate the activities, roles, operation, maintenance, and optimal use of multiple plant-cultivation enhancement and monitoring technology subsystems, the system comprising:
A computational element for executing at least one algorithm comprised by software, the at least one algorithm comprising configurable sensor input functions, configurable numerical computation operations, configurable logic operations, configurable dynamic controller operations, and configurable control output functions, the computational element further having network capabilities and provisions for control by user interfaces, the computational element further having interfacing capabilities to interface with sensors, controllable illumination, and controllable machinery; and
At least one graphical user interface algorithm comprised by software for executing on a computational device, the computational device having network capabilities and networked to the computational element, the graphical user interface algorithm and computational device exchanging information with the computational element and at least one algorithm,
Wherein the configurable sensor input functions, configurable numerical computation operations, configurable logic operations, configurable dynamic controller operations, and configurable control output functions are individually configured by information received by the graphical user interface algorithm; and
Wherein interconnections of information exchange among the configurable sensor input functions, configurable numerical computation operations, configurable logic operations, configurable dynamic controller operations, and configurable control output functions are individually configured by information received by the graphical user interface algorithm.

2. The system of claim 1 wherein a flexible/customizable GUI feature selection is provided.

3. The system of claim 1 wherein a flexible/customizable GUI look-and-feel is provided.

4. The system of claim 1 wherein various subsets of the available display and control objects are selected to create a particular type of GUI.

5. The system of claim 1 wherein subsets of available objects chosen for a particular GUI type are shared by more than one GUI type.

6. The system of claim 1 wherein subsets of available objects chosen for a particular GUI type is uniquely dedicated to a particular GUI type.

7. The system of claim 1 wherein subsets of available objects chosen for a particular GUI type are hierarchically shared among at least two GUI types.

8. The system of claim 1 wherein a GUIs is implemented with traditional application software methods.

9. The system of claim 1 wherein the traditional application software GUI is implemented using a “skins” programming pattern.

10. The system of claim 1 wherein a GUI is implemented as webpages.

11. The system of claim 1 wherein a webpage-based GUIs can be implemented using Cascading Style Sheets (CSS).

12. The system of claim 1 wherein a GUI provides for entering, reviewing, and changing a user setting.

13. The system of claim 1 wherein a GUI provides for entering, reviewing, and changing an operating mode.

14. The system of claim 1 wherein a GUI provides for entering, reviewing, and changing a configuration.

15. The system of claim 1 wherein a GUI provides for monitoring.

16. The system of claim 1 wherein a GUI provides for logging.

17. The system of claim 1 wherein a GUI provides for analysis.

18. The system of claim 1 wherein a GUI provides for testing.

19. The system of claim 1 wherein a GUI provides for diagnostics.

20. The system of claim 1 wherein an Application Programmer Interface is provided.
